(19) United States
(12) Patent Application Publication
(10) Pub. No.: US 2010/0091818 A1
(43) Pub. Date: Apr. 15, 2010

(54) DYNAMIC CHANNEL EVALUATION IN WIRELESS COMMUNICATION DEVICE

(76) Inventors: Indranil S. Sen, Mundelein, IL (US); Mark R. Braum, Elgin, IL (US); James A. Van Bosch, Crystal Lake, IL (US)

Correspondence Address: MOTOROLA INC, 600 NORTH US HIGHWAY 45, W4 - 39Q, LIBERTYVILLE, IL, 60048-5343, US

(21) Appl. No.: 12/251,118

(22) Filed: Oct. 14, 2008

(51) Int. Cl. H04B 1/713

(52) U.S. Cl. 375/136; 375/E01.033

(57) ABSTRACT

A frequency hopping wireless communication device including a controller configured to evaluate channels received by the wireless receiver for interference and to identify channels subject to interference as being unavailable for use by the wireless communication device. The controller is also configured to re-evaluate channels identified as being unavailable for use by the wireless communication device after expiration of a channel assessment time-out interval, and to dynamically change the channel assessment time-out interval based on location or mobility of the wireless communication device.

### FIELD OF THE DISCLOSURE

The present disclosure relates generally to wireless communications and more specifically wireless communication devices and implementing adaptive frequency hopping schemes in therein, and corresponding methods.

### BACKGROUND

The presence of numerous wireless standards operating at or near 2.4 GHz including, among others, cordless telephony, WiMAX, 802.11b/g/n, Bluetooth (BT), and ZigBee has resulted in growing concerns about signal interference and performance degradations for communication devices operating in the 2.4 GHz unlicensed Industrial Scientific Medical (ISM) band. To address these concerns, the Bluetooth Special Interest Group (SIG) has specified an Adaptive Frequency Hopping (AFH) method for modifying the frequency hopping sequence of Bluetooth in order to avoid in-band interferers. AFH is a form of frequency hopping that detects the interfered frequency channels and removes them from a channel map of the affected communication device. Removed frequency channels are unavailable for use by the communication device. The AFH algorithm also reinserts previously removed frequency channels into the channel map once the interfering sources are removed.

Current channel release algorithms rely primarily on periodic channel assessment scans of the radio frequency environment to determine the presence of interference. U.S. Publication No. 2006/0133543 entitled “Method and Apparatus for Performing Channel Assessment in a wireless Communication System” discloses a data collection engine that obtains channel metrics indicating the level of interference for each channel in a communication system and that provides a channel map for AFH and/or for channel avoidance. For AFH channel mapping applications, channels within a channel block having a metric sum that exceeds a threshold value are classified as unusable. For channel avoidance applications, a center frequency of a channel block having the worst interference is determined based on the metric sum and channels within a predetermined bandwidth about the center frequency are classified as unusable.

There are two things that determine the effectiveness of the AFH algorithm. The first is the time taken by the affected device to detect interference after the interfering source is introduced. The second is the time required to release the channels (previously removed from the channel map) once the interference source affecting those channels no longer exists. Bluetooth device suppliers currently select a long fixed channel release time in order to optimize performance when the host device is stationary.

In portable wireless communications devices current drain is also a consideration. AFH algorithms that frequently check for interferers in a static environment may use more power than necessary. However, when the user is mobile a long channel release time may be undesirable in areas with numerous interferers as more and more channels will be removed from the channel map before being reinserted back into the channel map. Accordingly, there is a need to provide an improved device and methodology for determining the optimal channel release time for wireless portable devices in the presence of interferers.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates multiple wireless communication devices communicating at or near the same frequency.

FIG. 2 is a schematic bock diagram of a wireless communication device.

FIG. 3 illustrates a schematic block diagram of a channel assessment timer controller.

FIG. 4 is a block flow diagram for controlling a channel assessment timer duration.

FIG. 5 is a block flow diagram for determining a condition of the wireless communication device.

### DETAILED DESCRIPTION

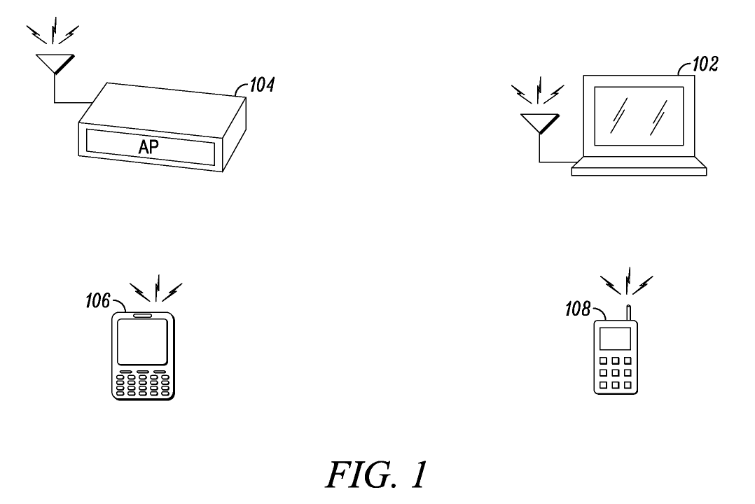

FIG. 1 illustrates multiple wireless communication devices that communicate on or near the same frequency resulting in potential interference in one or more devices. The interference to which the devices are subject includes but is not limited to in-band interference. In FIG. 1, for example, an 802.11b/g/n/x device 102 communicates with an access point 104. Bluetooth enabled devices 106 and 108 communication with other Bluetooth devices. More generally, the wireless device could be any wireless device that has the capability of determining the presence of external radio devices operating in the same or nearby frequency spectrum. In the exemplary embodiment, these and other devices, for example, cordless telephones and ZigBee enabled devices, communicate in the 2.4 GHz unlicensed Industrial Scientific Medical (ISM) band resulting in potential interference and performance degradation for these and other wireless devices operating in or near the same frequency.

To address these potentialities, the Bluetooth Special Interest Group (SIG) has specified an Adaptive Frequency Hopping (AFH) method for modifying the frequency hopping sequence of Bluetooth in order to avoid in-band interferers. In AFH, frequency channels subject to interference are detected and removed from a channel map, or list of channels, rendering the removed channels unavailable for use by the device. The AFH algorithm also reinserts previously removed frequency channels into the channel map once the interfering sources are removed. This AFH method is applicable to communications in frequencies or bands other than those specified by Bluetooth and thus the teachings of the present disclosure are not limited to Bluetooth applications. For example, other technologies which use frequency hopping as a tool to avoid interference would benefit from the teachings of the present disclosure. Similarly, cognitive radio devices that dynamically change their frequency band based on the presence of other activity in the spectrum would also benefit from the teachings of the instant disclosure.

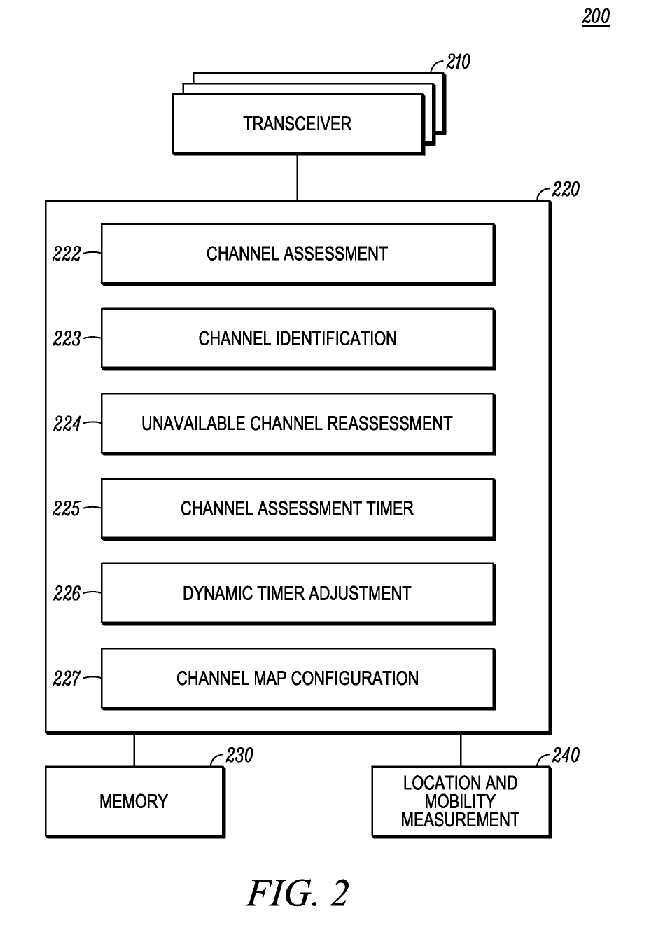

FIG. 2 illustrates a block diagram of a wireless communication device 200 that operates in a frequency hopping mode and particularly a wireless device capable of implementing an AFH operating mode. The device includes a wireless transceiver 210 communicably coupled to a controller 220 that is communicably coupled to memory 230. The transceiver 210 is more generally representative of one or more wireless transceivers, at least one of which operates in a frequency hopping mode. Exemplary transceivers that operate in frequency hopping mode include, but are not limited to, Bluetooth protocol compliant transceivers, cordless phones, military radios, etc. The other transceivers may be embodied as a cellular transceiver or a WLAN transceiver or a near-field communication (NFC) transceiver among other wireless transceivers and combinations thereof. In one implementation, the controller is a digital processor that executes instructions in the form of firmware or software, wherein the controller is configured to perform various functions or operations discussed more fully below. Alternatively, the functionality of the controller may be implemented by hardware equivalent circuitry or as a combination of hardware and software components.

According to one aspect of the disclosure, in FIG. 2, the controller 200 of the wireless communication device operating in a frequency hopping mode includes channel assessment functionality 222 that assesses a plurality of channels received by the transceiver for interference. The channels or frequencies are typically scanned and then evaluated for interference. The device obtains one or more measurements for each channel or frequency scanned and then performs the interference evaluation based on the measurements. In the exemplary embodiment, the channel scanning and assessment is performed or managed by a controller executing software or firmware. In one embodiment the channel interference is evaluated based on received signal strength indicator (RSSI) scans or based on the signal to interference and noise ratio (SINR) or signal to noise ratio (SNR). Alternatively, the interference is evaluated based on packet error statistics, for example, bit error rate (BER), packet error rate (PER) or block error rates (BLER). The evaluation may also be based on a combination of these and other factors. Based on this evaluation, the frequency channel can then be marked or classified as good, bad or unknown. This process is also referred to as channel classification. In one implementation, the transceiver is tuned to scan all channels during each scanning interval whereupon the signal measurements are made for each channel. In this embodiment, only the channels that are available for use by the wireless communication device are evaluated for interference. In another embodiment, the transceiver is tuned to scan, and the processor obtains measurements for, only the channels that are available for use by the wireless communication device. In this latter embodiment, no evaluation is made for the channels that are not scanned. Generally the channel scanning and evaluation is performed repeatedly, for example, over a periodic interval or irregular intervals.

In FIG. 2, the controller also includes functionality 223 enabling the classification, for example, by the identification, of one or more channels that are available or unavailable for use by the wireless communication device based on interference associated with the corresponding channel. Channels that are identified as being unavailable are generally subject to an unacceptable level of interference. In one embodiment, the criterion for removing a channel is the evaluation of an RSSI or SINR or SNR or BER or PER or BLER associated with the channel relative to a corresponding threshold. In one implementation, the controller maintains a list of channels that are available to the wireless communication device operating in the frequency hopping mode. Channels that are subject to unacceptable levels of interference may be removed from the list. Alternatively, channels that are unavailable may remain on the list but they may be flagged or otherwise identified as being unavailable. In another embodiment, the unavailable channels may be maintained on a designated list containing only channels that are subject to interference. In FIG. 2, the controller includes channel map configuration functionality 227 that enables the identification of channels that are available or unavailable for use by the wireless communication device. These and other schemes may be used to identify the channels that are unavailable for use by the wireless communication device.

Generally, channels that are unavailable for use by the wireless communication device are re-evaluated after some time interval to determine whether the unavailable channels may be re-classified as available. The re-classification may occur by re-introducing the channel to the channel map of available channels or otherwise indicating that the channel is available. In FIG. 2, the controller includes functionality 224 that re-evaluates the one or more channels that are unavailable for use by the wireless communication device. In one embodiment, the channels that are unavailable for use by the device are re-evaluated only after expiration of a corresponding channel assessment timer. In FIG. 2, the controller includes a channel assessment timer 225, which is implemented in software or firmware. The duration of the channel assessment timer is referred to herein as the channel assessment time-out interval. Alternatively, the timer may be implemented in hardware or as a combination of hardware and software. In operation, the channel assessment timer is started when a channel is identified or classified as being unavailable. More generally, the timer 225 is implemented as multiple channel assessment timers wherein there is a corresponding timer for each channel identified as being unavailable. The unavailable channels are not re-scanned or at least not re-evaluated, for possible re-introduction as an available channel, until the corresponding timer has timed-out or expired. Thus the unavailable channel or channels are not necessarily scanned or evaluated during every scanning interval, depending on the period of the channel assessment timer and the frequency with which the channels are re-scanned or re-evaluated. The channels that remain available for use by the communication device may be re-evaluated during the channel assessment time-out interval. Only channels that are unavailable to the wireless communication device are not evaluated during the channel assessment time-out interval. In other words, while the channel assessment timer is running, only the channels that are available may be evaluated or re-evaluated for interference.

In one embodiment, the duration of the channel assessment timer is adjusted dynamically. Generally, the value of the timer may be adjusted either after the timer is started or upon expiration of the timer. In FIG. 2, the controller includes dynamic timer adjustment functionality 226 that enables the dynamic adjustment of the period of the channel assessment timer or timers. In one implementation, the duration of the channel assessment timer is dynamically adjusted based on a condition of the wireless communication device.

In a more particular implementation, the condition of the wireless communication device is a measure of its mobility. Mobility may be measured, for example, as the velocity or acceleration of the wireless communication device. In one embodiment, the channel assessment timer has a relatively long duration when the wireless communication device is stationary and the timer has a relatively short duration when the wireless communication device is moving. According to this embodiment, generally, the duration of the channel assessment timer decreases with increasing mobility and the duration of the channel assessment timer increases with decreasing mobility. In another more particular implementation, the condition of the wireless communication device is a determination of its location. In this latter implementation, the channel assessment timer is dynamically adjusted based on the location of the wireless communication device.

In FIG. 2, the wireless communication device includes a location and mobility measurement module 240 that may be implemented as hardware or software. The location and mobility measurement module is generally capable of determining the location and the mobility, for example, velocity and acceleration, of the wireless communication device. In one embodiment, the module 240 is a satellite positioning system (SPS) receiver, for example, a GPS or GLONASS or Galileo satellite navigation signal receiver. Alternatively, the mobility measurement module determines the mobility or location of the wireless communication device based on terrestrial signals. In terrestrial mobility measurement implementations, the location and velocity of the wireless device may be computed based on the receipt of multiple terrestrial based signals, for example, base station signals. Exemplary terrestrial location schemes include uplink time difference of arrival (U-TDOA), time of arrival (TOA), angle of arrival (AOA), enhanced observed time difference (E-OTD) among other algorithms. In other embodiments, a combination of terrestrial and satellite signals may be used to determine location and mobility. Additionally, relatively coarse measures of location and mobility may be obtained based on location updates, for example, changes in the received Public Land Mobile Network (PLMN) information, experienced by the wireless communication device, without the use of such algorithms.

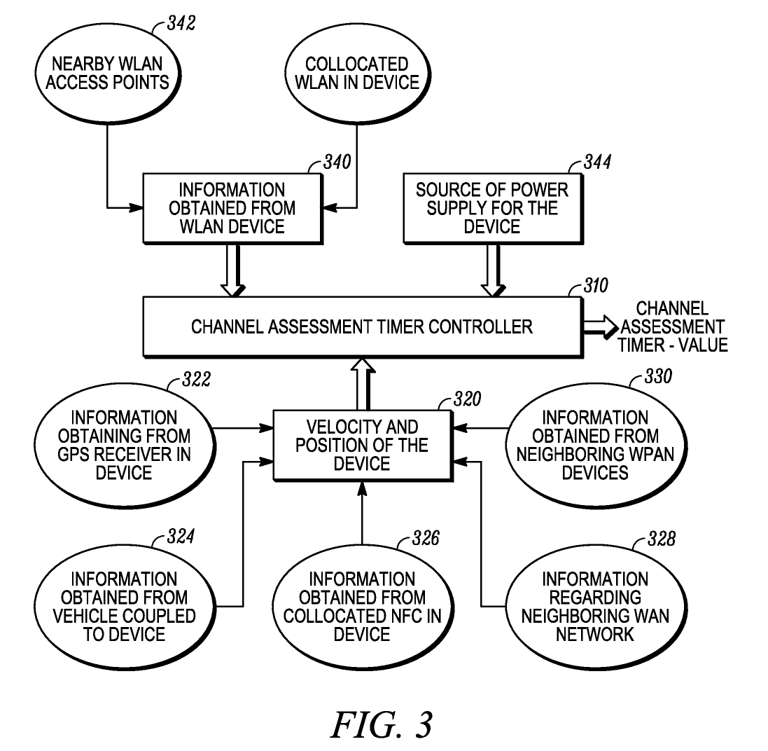

In FIG. 3, the channel assessment timer controller 310 may obtain location or mobility information 320 from a GPS receiver source 322 or from a source 324 that is associated with a vehicle in which the device is located. Alternatively, the location or mobility information may be obtained from a near-field communication (NFC) source 326 within the wireless communication device. For example, the location of a wireless communication device may be determined or inferred based on where or when a user of the device uses an NFC application. Exemplary uses of NFC applications include, but are not limited to, use for bus/train ticketing, proximity payments, poster reading or event ticketing, among other uses. In FIG. 3, location and mobility information may be obtained from neighboring wide area network (WAN) devices 328, for example, from WiMAX and cellular communications infrastructure entities. The location and mobility information may also be obtained from information obtained from neighboring wireless personal area network (WPAN) devices 330, for example, from neighboring Bluetooth, ZigBee, and Bluetooth Low Energy, e.g., Wibree, devices among others. FIG. 3 illustrates a wireless local area network (WLAN) receiver 340 that obtains information from WLAN access points that is used to determine location and mobility information that may be used to dynamically control the channel assessment time-out interval.

According to a related aspect of the disclosure, the wireless device configures a channel map based on the location of the wireless communication device and operates in frequency hopping mode based on the configured channel map. The channel may be configured to identify channels that are available for use by the device or to identify channels that are not available for use by the wireless communication device. The channel map configuration may be based on channel map configuration data stored on the wireless communication device. Such stored data may be historical data based on a previous configuration of the channel map at the particularly location.

In another implementation, the duration of the channel assessment timer is dynamically adjusted based on a number of channels that are available for use by the wireless communication device. In one embodiment, the fewer the number of available channels, the shorter the duration of the channel assessment timer. For example, the Bluetooth standard requires that the device maintain a minimum number of channels on the channel map. Thus in some applications if the number of available channels decreases, it may be desirable to shorten the interval after which an unavailable channel becomes eligible for re-introduction into the channel map.

In another implementation, the condition of the wireless communication device is its mode of operation. In this implementation, channel assessment timer is dynamically adjusted based on whether the wireless device is operating in an active mode or an idle mode or some other mode. For example, for idle mode operation, the duration of the channel assessment timer may be relatively long to reduce power consumption associated with the scanning and assessment. In active mode operation, the duration of the channel assessment timer may be relatively short.

In another implementation, the signal strength of the desired signal can be used to set a threshold of whether to perform channel classification. If the desired signal strength is high between the two communicating devices in relation to the interfering signal source then channel classification is not needed as the signal to noise ratio of the desired signal is high enough to overcome the interfering signal. If the desired signal strength is low between the two communicating devices in relation to the interfering signal source then channel classification is needed as the signal to noise ratio of the desired signal is low and will not be able to overcome the interfering signal.

In another implementation, the duration of the channel assessment timer is dynamically adjusted based on the strength of interference affecting the channel unavailable to the wireless communication device. In this embodiment, the condition of the device is a measure of the interference to which it is subject. Thus where the interference is relatively strong, the duration of the channel assessment timer is relatively long whereas it may be relatively short where the interference is relatively weak. Further, the duration of the channel assessment timer may be reduced where there is an indication that the interference is decreasing on the assumption that the wireless communication device will no longer be subject to the interference sooner rather than later.

In another implementation, the duration of the channel assessment timer is dynamically adjusted based on whether the wireless communication device is coupled to an external power source. FIG. 3 illustrates a functional block 344, which may be implemented by the controller, capable of determining the source of power to the wireless device. When the device is coupled to external power, rather than battery power, the duration of the channel assessment timer may be decreased without concern over depleting the battery. A shorter value of the channel assessment timer will generally result in more power consumption than a longer value of the timer since channel measurements and assessments are made more frequently when the time-out duration is shorter. Thus channel assessment timer may be adjusted whenever the device is coupled to or de-coupled from an external power source.

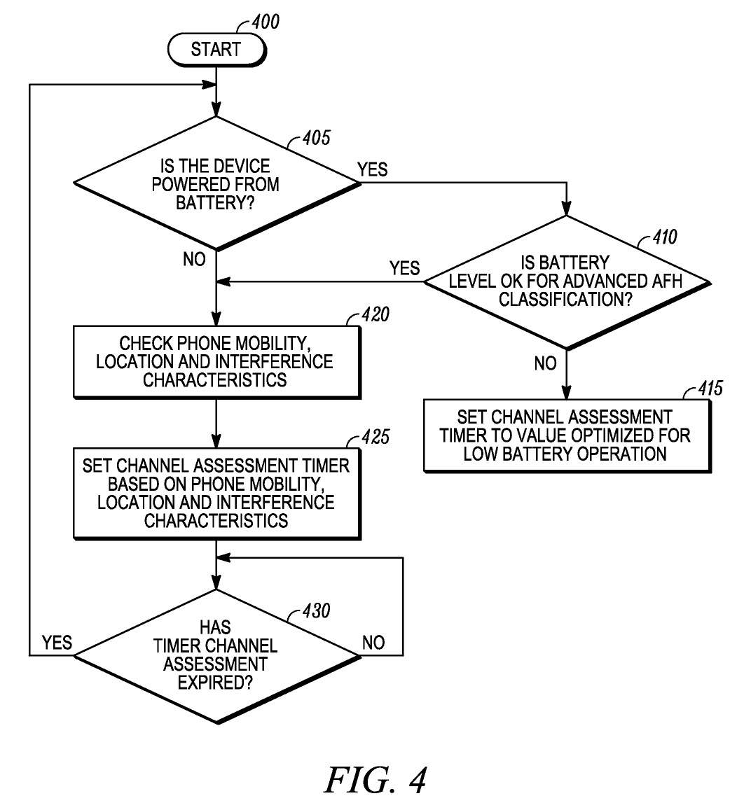

FIG. 4 illustrates a process implemented by a wireless communication device operating in frequency hopping mode wherein the duration of a channel assessment timer is dynamically adjusted for one or more channels or frequency bins based on one or more conditions of the wireless communication device. A frequency bin is generally defined as a band of frequencies of a specific width. Generally there is an individual channel assessment timer for each individual channel. At 405, the device determines whether or not it is powered by a battery or an external power supply. If the device as powered by a battery, at 410, the device determines whether there is sufficient battery capacity to perform channel assessment with a dynamically adjusted channel assessment timer. If not, at 415, the device uses a channel assessment timer duration that is optimized for the level of battery power available. The duration of the channel assessment timer may be fixed or alternatively it may change with changes in the available battery power, preferably in a manner that reduces power consumption as the battery becomes more depleted.

In FIG. 4, at 420, the condition of the wireless communication device, for example, a phone is checked. As suggested above, the condition may be the location or mobility or mode of operation of the device or the level of interference experienced by the device among other conditions. At 425, the channel assessment timer duration associated with a channel is adjusted based on the condition of the device. At 430, upon expiration of the channel assessment timer, the device goes back to 405 and the algorithm is repeated. The process of FIG. 4 may be implemented by a controller of the wireless communication device.

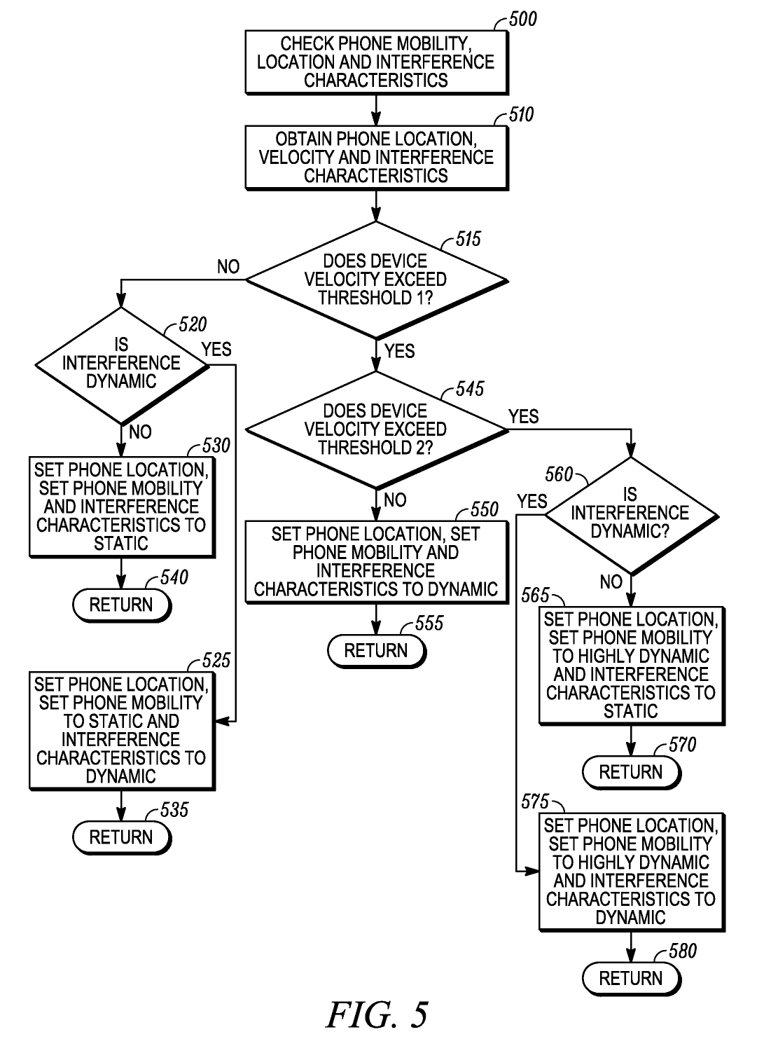

In the process 500 of FIG. 5, at 510, the wireless device operating in frequency hopping mode determines its location and mobility. At 510, the device also determines the interference to which it is subjected. At 515, a determination is made as to whether the mobility, for example, the velocity or acceleration, of the device exceeds a first threshold. If the velocity does not exceed the first threshold, the device is assumed to be either stationary or at least relatively stationary. For example, a relatively stationary device may be one that is moving at a rate less than or equal to a walking pedestrian. In other embodiments, other criteria may be used to evaluate whether the mobility exceeds the first threshold. If the first threshold is not exceeded, at block 520, a determination as to whether the interference to which the device is subject is dynamic or static. The characteristic of the interference may be based on a measure of the rate of change of the interference intensity among other factors. In FIG. 5, at 525, the dynamic interference, static mobility and the location of the device are used as a basis for dynamically adjusting the duration of the channel assessment timer. At 535, the process returns to block 420 in FIG. 4 and then in step 425, the channel assessment timer duration is set accordingly. As suggested above, for a stationary or relatively immobile wireless device the timer duration is relatively long. The timer duration may also be a function of the location of the wireless device, for example, based on historical data obtained for a particular location. For example, in step 525 the device mobility is set to static and the interference environment is set to dynamic, thus in step 425 the channel assessment timer could be set to 5 seconds to optimize performance using moderate current drain in the channel assessment process.

In FIG. 5, at 530, the static interference and mobility and the location of the device are used as a basis for dynamically adjusting the duration of the channel assessment timer. At 540, the process returns to block 420 in FIG. 4 and then in step 425, the channel assessment timer duration is set accordingly. For example, in step 425 the channel assessment timer could be set to a long duration (e.g. 10 seconds) to optimize performance using minimal current drain in the channel assessment process.

In FIG. 5, at 515, if the mobility of the device does exceed the first threshold, the process proceeds to 545 where a determination is made as to whether the device exceeds a second threshold. At 545, if the second threshold is not exceeded, the device determines that it's dynamic. The process proceeds to 550 wherein the location and mobility of the device and the interference characteristic are used as a basis for dynamically adjusting the duration of the channel assessment timer. At 555, the process returns to block 420 in FIG. 4 and then in step 425, the channel assessment timer could be set to a very short duration (e.g. on the order of milliseconds) to optimize performance using higher current drain in the channel assessment process. The number of Bluetooth packet retransmissions may be reduced because the shorter channel assessment timer allows the best channels to be available in the map. The increase in current drain due to the channel assessment process may be offset due to the reduced number of Bluetooth packet retransmissions.

At 545, if the mobility of the device exceeds the second threshold, the process proceeds to 560 where a determination is made as to whether the interference is dynamic. In FIG. 5, at 565, the static interference, the relatively high mobility, and the location of the device are used as a basis for dynamically adjusting the duration of the channel assessment timer. At 570, the process returns to block 420 in FIG. 4 and then in step 425, the channel assessment timer could be set to a long duration (e.g. 10 seconds) to optimize performance using minimal current drain in the channel assessment process.

In FIG. 5, at 575, the dynamic interference, the relatively high mobility, and the location of the device are used as a basis for dynamically adjusting the duration of the channel assessment timer. At 580, the process returns to block 420 in FIG. 4 and in step 425, the channel assessment timer duration could be set to 5 seconds to optimize performance using moderate current drain in the channel assessment process.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A frequency hopped wireless communication device, comprising:
a wireless receiver;
a controller coupled to the wireless receiver,
the controller configured to evaluate channels received by the wireless receiver for interference and to identify channels subject to interference as being unavailable for use by the wireless communication device,
the controller configured to re-evaluate channels identified as being unavailable for use by the wireless communication device after expiration of a channel assessment time-out interval,
the controller configured to dynamically change the channel assessment time-out interval.

2. The device of claim 1, the controller configuring the channel map based on the signal strength of the desired signal.

3. The device of claim 1, the controller configured to evaluate channels, other than the channel that is unavailable for use by the wireless communication device, during the channel assessment time-out interval.

4. The device of claim 1, the controller configured to dynamically adjust the channel assessment time-out interval based on a measure of mobility of the wireless communication device.

5. The device of claim 1, the controller configured to provide a relatively long channel assessment time-out interval if the wireless communication device is stationary and to provide a relatively short channel assessment time-out interval if the wireless communication device is moving.

6. The device of claim 1, the controller configured to dynamically adjust the channel assessment time-out interval based on a location of the wireless communication device.

7. The device of claim 1, the controller configured to decrease the channel assessment time-out interval if a velocity of the wireless communication device increases and to increase the channel assessment time-out interval if a velocity of the wireless communication device decreases.

8. The device of claim 1, the controller configured to dynamically adjust the channel assessment time-out interval based on a number of channels available for use by the wireless communication device.

9. The device of claim 1, the controller configured to dynamically adjust the channel assessment time-out interval based on whether the wireless communication device is operating in an active mode or an idle mode.

10. The device of claim 1, the controller configured to dynamically adjust the channel assessment time-out interval based on a strength of interference affecting the channel that is unavailable for use by the wireless communication device.

11. The device of claim 1, the controller configured to dynamically change the channel assessment time-out interval during a communication session.

12. The device of claim 1, a battery coupled to the controller, the controller configured to dynamically change the channel assessment time-out interval based on unused battery capacity.

13. A wireless communication device, comprising:
a wireless receiver;
a controller coupled to the wireless receiver,
the controller configured to configure a channel map identifying channels that are either available or unavailable for use by the wireless communication device,
the channel map configured based on a location of the wireless communication device;
the controller configured to operate wireless communication device in frequency hopping mode based on the configured channel map.

14. The device of claim 13, the controller configuring the channel map based on the signal strength of the desired signal.

15. The device of claim 13, the controller configuring the channel map based on historical channel map configuration data stored on the wireless communication device.

16. The device of claim 13,
the controller configured to set a channel assessment time-out interval based on the location of the wireless communication device,
the controller configured to evaluate the channels that are unavailable for use by the wireless communication device only after expiration of a channel assessment time-out interval.

17. The device of claim 16, the controller configured to dynamically adjust the channel assessment time-out interval based on a change in location of the wireless communication device.

18. The device of claim 16, the controller configured to dynamically adjust the channel assessment time-out interval based on a measure of mobility of the wireless communication device.

19. The device of claim 16, the controller configured to dynamically adjust the channel assessment time-out interval based on a location of the wireless communication device.

20. The device of claim 16, the controller configured to obtain a measure of velocity of the wireless communication device, the controller configure to decrease the channel assessment time-out interval if the velocity increases and increase the channel assessment time-out interval if the velocity decreases.

21. The device of claim 16, the controller configured to dynamically adjust the channel assessment time-out interval based on a number of channels available for use by the wireless communication device.

22. The device of claim 16, dynamically adjusting the channel assessment time-out interval based on whether the wireless communication device is operating in an active mode or an idle mode.

23. The device of claim 16, the controller configured to dynamically adjust the channel assessment time-out interval based on a strength of interference affecting the channel that is unavailable for use by the wireless communication device.

24. The device of claim 16, the controller configured to dynamically adjust the channel assessment time-out interval based on whether the wireless communication device is coupled to an external power source.
